(19) United States
(12) Patent Application Publication
(10) Pub. No.: US 2026/0243168 A1
(43) Pub. Date: Aug. 20, 2026

(54) ROTOR ASSEMBLY WITH INDEPENDENT PLATFORMS AND METHOD FOR ASSEMBLING SUCH A ROTOR

(71) Applicant: SAFRAN AIRCRAFT ENGINES, PARIS (FR)

(72) Inventors: Simon Jean-Marie Bernard COUSSEAU, MOISSY CRAMAYEL (FR); Yannick DURAND, MOISSY CRAMAYEL (FR); Baptiste Dorian LAWNICZEK, MOISSY CRAMAYEL (FR)

(21) Appl. No.: 19/153,902

(22) PCT Filed: Jan. 30, 2024
(86) PCT No.: PCT/FR2024/050120

§ 371 Date: Aug. 5, 2025

(30) Foreign Application Priority Data
Feb. 6, 2023 (FR) 2301088

(51) Int. Cl. F01D 5/02; F01D 17/18

(52) U.S. Cl. CPC F01D 5/021; F01D 17/18; F05D 2230/60

(57) ABSTRACT

A turbine rotor assembly of a turbine engine includes a rotor disc centred on an X-axis and having recesses, movable blades each including a root mounted in a recess, a plurality of platforms for holding the movable blades in the recesses of the disc, and a flange for holding the movable blades in the recesses, each platform including a duct wall defining a gas flow duct, an L-shaped downstream hook with a vertical portion extending radially from the duct wall and a horizontal portion housed in a holding hook positioned at the top of a tooth of the disc, and an upstream hook extending substantially radially from an upstream area of the duct wall and held axially between the flange and the disc.

### TECHNICAL FIELD OF THE INVENTION

This invention relates to a turbine rotor assembly the platforms of the movable vanes of which are independent of the blades of said movable vanes. It also relates to a method for mounting these movable vanes in the rotor disc.

The invention finds applications in the field of aeronautics and, in particular, in the field of low-pressure turbines for aircraft turbomachines.

### TECHNOLOGICAL BACKGROUND OF THE INVENTION

In a known manner, a low-pressure (LP) turbine comprises several successive vaned impellers, separated by distributor stages. A vaned impeller, also referred to as an impeller, comprises so-called “movable” vanes and a rotor disc. Each movable vane generally includes a blade extending to a vane root. The outer periphery of the rotor disc includes mounting grooves, referred to as cavities, which extend along substantially axial directions (i.e. at an angle of up to a few degrees relative to the axial direction). Each cavity is designed so as to receive the root of a movable vane fittingly mounted into said cavity.

Conventionally, the movable vanes each include a platform circumferentially extending around the blade of the vane, in a plane substantially perpendicular to the plane containing the blade. The platforms are designed to form, together with the platforms of the other movable vanes, an inner stream in which hot gases passing through the turbine circulate. On conventional vanes, generally derived from foundry, the platform is integrated into the movable vane, i.e. it is made as one piece with the blade and the vane root.

Usually, there is a first axial retention annulus, or flange, arranged on the upstream face of the turbine disc and a second axial retention annulus, arranged on the downstream face of the turbine disc. These annuli form axial stops for the vane roots housed in the cavities. One example of a LP turbine portion including three vaned impellers 1a, 1b, 1c according to the state of the art is represented in FIG. 1. The vaned impellers 1a, 1b, 1c are separated from each other by distributors 7, 8, each equipped with a shroud 9, 10 forming the inner wall of the flow stream F. Each vaned impeller 1a, 1b, 1c comprises a disc rotating about the central axis of the turbine, depicted by the axis X, and including an external peripheral rim 2a, 2b, 2c, to which the vanes are attached by their root 3a, 3b, 3c. In particular, a first impeller 1a includes a movable vane 4a axially mounted, by its root 3a, in a cavity 6a of the rim 2a of the disc. The root 3a of the vane 4a is axially blocked, upstream, by an annular flange 13 and, downstream, by an annular flange 14, the flanges 13 and 14 being of different types.

Nowadays, the movable vanes of turbines, especially low-pressure (LP) turbines, are often made from a ceramic matrix composite (CMC), which has the advantage of being light. CMC vanes are therefore lighter than conventional metal vanes. However, the manufacture of CMC vanes with a holding hook is complex because it involves weaving and requires two texture layers to be formed on the vane, at the platform 5a, 5b, 5c located between the blade and the root 3a, 3b, 3c of the vane, one of the texture layers forming the surface delimiting the air stream and the hook and the other serving as a non-tilt member for the vane and to downstream coverage.

To solve this problem, it has been suggested dissociating the platform from the blade and the root of the vane. However, the fact that the platforms are independent of the blade and vane root assembly creates a problem in terms of transferring the centrifugal force. Indeed, each platform is carried by the two adjacent blade and vane root assemblies (referred to hereafter as vanes), for example, by means of a retaining shoulder resting on each of the two circumferentially adjacent vanes. The centrifugal force of each platform is then transferred to the two circumferentially adjacent vanes: the centrifugal force passes through the vane root and the vane-disc attachment of each of the two adjacent vanes to be taken up by the disc. In addition to the centrifugal force of the vane itself, the vane-disc attachment is therefore loaded by the centrifugal force of the platform. As the centrifugal force of the platform is not negligible compared with that of the vane, the load on the vane/disc attachment increases significantly.

One solution to lighten this vane-disc load could be to use fir tree root-shaped vane-disc attachments (i.e. with several span stages). However, the current state of the art for CMC vanes does not allow the manufacture of fir-tree root-shaped vane-disc attachments. Current knowledge limits the attachment to the simplest shape known as the “dovetail”. It is therefore not possible to increase capacity of the vane-disc attachment by adding a span stage.

To make a LP turbine with CMC vanes and independent platforms, it is therefore necessary to respect the permissible centrifugal force limit of a vane-disc attachment, this limit having been determined as a function of the implantation radius, the number of vanes and the chord at the root of the vane.

There is therefore a real need for a technology for limiting mechanical loading of the vane/disc attachment for CMC vanes with independent platforms (as opposed to integrated platforms).

### SUMMARY OF THE INVENTION

In response to the problems discussed above of transferring the centrifugal forces from the platform to the vane/disc attachment, the applicant provides a platform equipped with a downstream hook anchored to the top of a tooth of the disc and an upstream hook axially held by a flange.

In the following description, the terms “upstream” and “downstream” are defined relative to the air flow direction from the air inlet to the LP turbine to the air outlet from the LP turbine. In other words, upstream and downstream are understood along a central axis X with respect to the general direction of gases in operation.

In the description, the term “external” designates surfaces or parts of pieces furthest from the central axis X of the turbomachine air stream (i.e. the axis of rotation of the fan vanes), as opposed to the term “internal” which designates surfaces and parts of pieces closest to said central axis X.

According to a first aspect, the invention relates to a turbomachine turbine rotor assembly of axis X including:
a rotor disc centred on the axis X and having cavities which open out at the outer periphery of the disc, two circumferentially adjacent cavities delimiting a tooth of the disc, and
movable vanes, each comprising a root mounted in one of the cavities of the disc and a blade extending from the root,
a plurality of platforms for holding the movable vanes in the disc cavities, each platform being circumferentially mounted between two circumferentially adjacent movable vanes, and
a flange for holding the movable vanes in the cavities.

This rotor assembly is characterised in that each platform includes:
a stream wall configured to delimit a turbomachine gas flow stream,
an L-shaped downstream hook with the vertical portion of the L radially extending from the stream wall and the horizontal portion of the L housed in a corresponding holding hook positioned at the top of a tooth of the disc; and
an upstream hook substantially radially extending from an upstream zone of the stream wall and axially held between the flange and the disc.

The platforms of this rotor assembly are designed to allow centrifugal force transfer from the platforms to the disc (unlike the state of the art, where the centrifugal forces are transferred to the vane-disc attachment), thereby limiting mechanical loading of the vane-disc attachment.

Further to the characteristics just discussed in the preceding paragraph, the rotor assembly according to one aspect of the invention may have one or several additional characteristics from among the following, considered individually or according to any technically possible combination:
the flange is annular in shape, radially mounted along an upstream face of the disc.
the upstream hook of each platform at least partially extends along an upstream face of the disc, between said upstream face of the disc and the flange.
the upstream hook of each platform is in the form of an inverted L with a vertical portion of the inverted L substantially radially extending from the stream wall and a horizontal portion of the inverted L substantially perpendicularly extending from the vertical portion of the inverted L and housed in a groove of the flange.
the upstream hook of each platform is L-shaped with a vertical portion of the L substantially radially extending from the stream wall and a horizontal portion of the L substantially perpendicularly extending from the vertical portion of the L and housed in a rib of the upstream face of the disc.
the upstream hook of each platform is L-shaped with a vertical portion of the L substantially radially extending from the stream wall and a horizontal portion of the L substantially perpendicularly extending from the vertical portion of the L and housed in a holding lug at the top of the disc tooth.
the downstream hook of each platform extends from a downstream zone of the stream wall, radially perpendicular to the holding hook of the disc tooth.
the downstream hook of each platform extends from a central zone of the stream wall, radially perpendicular to the hook for holding the disc tooth.
it includes an axial vane retaining annulus positioned downstream of the disc.
the platform includes a radial wall extending downstream, from the stream wall to the top of a disc tooth.
each platform includes a circumferential end edge with a complementary shape to the shape of a blade of the movable vane, a seal ring being housed in a recess of each circumferential end edge.
it includes a stop ring housed in a groove of the rotor disc, at a radially inner end of the flange, the stop ring being configured to secure the flange to the disc after mounting said flange has been to the disc.

A second aspect of the invention relates to a turbomachine, characterised in that it includes a rotor assembly according to the first aspect.

A third aspect of the invention relates to a method for mounting movable vanes in cavities of a rotor disc, characterised in that it includes the following steps of:
selecting a first and a second platform for holding the movable vanes,
installing a seal ring in a recess of a circumferential end edge of a stream wall of each of the first and second platforms,
assembling the first and second platforms circumferentially on either side of a movable vane,
assembling successive platforms, following each other, circumferentially on either side of movable vanes so as to form a crown of movable vanes,
assembling the crown of movable vanes in the disc by translating the vane roots into the disc cavities from an upstream face of the disc,
positioning a stop ring in a groove of the disc, and
positioning the flange in the groove of the disc, along the upstream face of the disc.

### BRIEF DESCRIPTION OF THE FIGURES

Further advantages and characteristics of the invention will become apparent upon reading the following description, illustrated by the figures in which:

FIG. 1, already described, represents a schematic longitudinal cross-section view of a part of a LP turbine with several vaned impellers according to the state of the art;

FIG. 2A schematically represents a partial cross-section view of a disc and a movable vane of a LP turbine rotor assembly according to one embodiment of the invention, the cross-section being along section line AA′ of FIG. 2C;

FIG. 2B schematically represents a partial cross-section view of a disc and a movable vane of a LP turbine rotor assembly according to the same embodiment of FIG. 2A, with a section along section line BB′ of FIG. 2C;

FIG. 3 schematically represents a partial perspective view of a disc and a vaned impeller of a LP turbine rotor assembly according to one embodiment of the invention;

FIGS. 4A, 4B, 4C and 4D schematically represent partial perspective views of a disc and a movable vane of a LP turbine rotor assembly according to different embodiments of FIGS. 2A and 2B;

FIGS. 5A and 5B schematically represent a perspective view and a cross-section view of a seal ring housed in each platform of the LP turbine rotor assembly; and

FIG. 6 schematically represents different perspective views of a disc and a vaned impeller of a LP turbine rotor assembly during the method for mounting the vaned impeller in the disc.

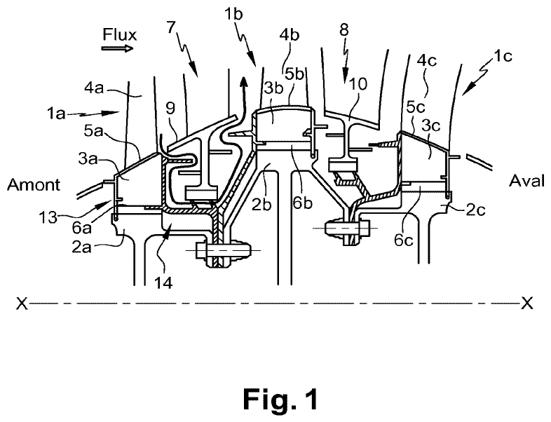

In the figures, identical elements are marked by identical references. For reasons of legibility of the figures, the size scales between elements represented are not respected.

### DETAILED DESCRIPTION

An exemplary embodiment of a LP turbine rotor assembly is described in detail hereinafter, with reference to the appended drawings. This example illustrates characteristics and advantages of the invention. It is, however, reminded that the invention is not limited to this example.

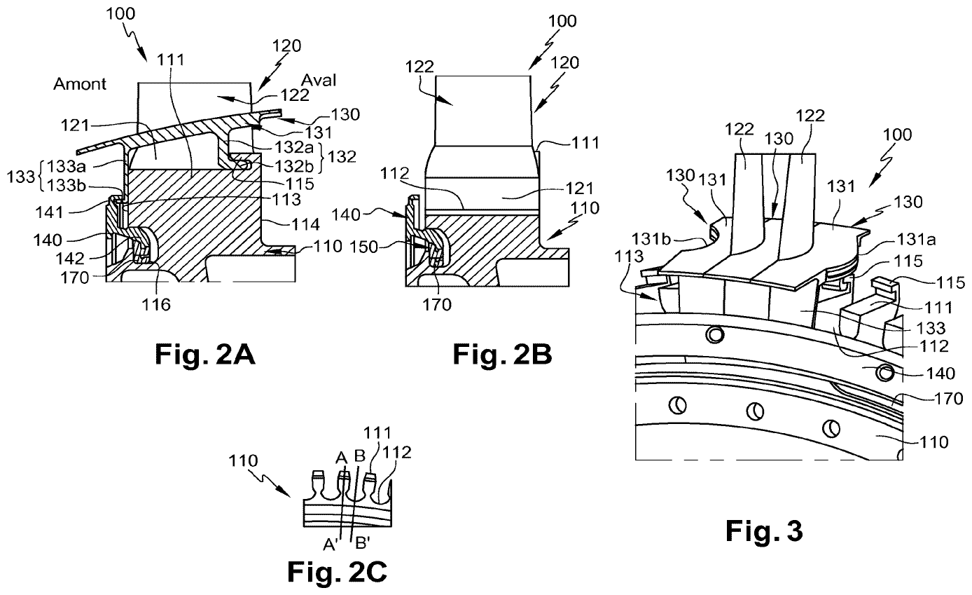

An example of a part of a LP turbine rotor assembly is represented in FIGS. 2A and 2B as well as in FIG. 3. In particular, FIG. 2A represents the LP turbine rotor assembly in a cross-section view along section line AA′ (shown in FIG. 2C) passing through the top of a tooth 111 of the disc 110. FIG. 2B represents this same LP turbine rotor assembly in a cross-section view along section line BB′ (shown in FIG. 2C) passing through the cavity 112 of the disc 110. FIG. 3 represents a perspective view of a portion of the disc 110 in which two blades 120 are mounted.

FIGS. 2A and 2B show a part of a movable vane 120, the blade 122 of which radially extends along a radial axis R, perpendicular to the axis of rotation X of the rotor, and the root 121 of which, herein dovetail-shaped, is housed in a cavity 112 of the disc 110. As a reminder, a LP turbine rotor disc includes a plurality of cavities 112 which open out at the outer periphery of said disc and axially extend between an upstream face 113 and a downstream face 114 of said disc, two successive cavities 112 being separated by a tooth 111.

A platform 130, independent of the vane 120, is mounted between the two blades 122 of two circumferentially consecutive vanes 120, as shown in FIGS. 2A and 3. The platform 130 includes a main wall 131 extending substantially axially (along the axis of rotation X) between the two blades 122 to form a gas circulation stream. The main wall 131, or stream wall, is preferably inclined from upstream to downstream, for example from inside the rotor towards outside or from outside towards inside the rotor; to form a more or less steep stream slope; the main wall 131 may alternatively not be inclined. The main wall 131 comprises two circumferential end edges 131a, 131b, respectively, convex and concave, each having a curvature adapted to the curvature of the blades 122. In particular, when a platform 130 is disposed between two circumferentially consecutive blades 122, the convex edge 131a embraces the shape of the lower surface of one of the blades and the concave edge 131b embraces the shape of the upper surface of the other of these two blades so as to ensure continuity of the gas circulation stream.

As shown in FIG. 2A, the platform 130 includes a downstream hook 132 and an upstream hook 133. The downstream hook 132 is an attachment, integral with the main wall 131, with an L-shaped cross-section. The L shape of the downstream hook 132 includes a leg 132a, or vertical portion, substantially radially extending from the main wall 131 towards the disc 110 and an arm 132b, or horizontal portion, substantially perpendicularly extending from the leg 132a towards downstream, into a first holding lug 115 positioned at the top of a tooth 111 of the disc 110. Regardless of the inclination of the main wall 131 of the platform 130, the downstream hook 132a extends from the main wall 131 of the platform 130, perpendicular to the holding hook 115 of the disc.

The upstream hook 133 is a lug, integral with the main wall 131, which radially extends from the main wall 131 along or in the continuity of the upstream face 113 of the disc 110. In some embodiments subsequently described later, the lug forming the upstream hook 133 is a planar and rectilinear tab. In other embodiments, such as that of FIG. 2A, the lug forming the upstream hook 133 is curved at its free end (or internal end) and has an inverted L-shaped cross-section. In these embodiments, the upstream hook 133 includes a leg 133a substantially radially extending from the main wall 131 towards the disc 110 and an arm 133b substantially perpendicularly extending from the leg 133a upstream to be housed in a groove 141 of the flange 140, itself integral with the disc 110. Indeed, the rotor assembly 100 includes a flange 140, or retaining annulus, radially mounted along the upstream face 113 of the disc 110. This flange 140, which is annular in shape, extends in parallel to the cavities 112 and inter-cavity teeth 111 of the disc 110 over the entire circumferential length of the disc. This flange 140, of a conventional shape for a LP turbine flange, includes a spoiler 142 at least partially housed in a groove 116 of the disc 110. This spoiler 142 ensures fastening of the flange 140 to the disc 110, making the flange integral with the disc 110. Thus mounted along the disc 110, the flange 140 extends upstream of the upstream face 113 of the disc to hold the vanes 120 axially (from downstream to upstream) in the disc 110.

It is thus understood that, in the embodiment of FIGS. 2A, 2B and 3, the platform 130 is secured to the disc 110, on the one hand, directly by means of the downstream hook 132 and, on the other hand, indirectly (via the flange 140) by means of the upstream hook 133. This architecture of the platform 130 enables the centrifugal forces to be transferred from the platform directly to the disc 110, avoiding excessive mechanical loading of the vane-disc attachment. This transfer of centrifugal forces from the platform also has the advantage of not requiring any additional pieces to those usually used in a LP turbine rotor assembly since the flange is a part usually used to hold the vanes; only the platform attachment means is modified so that the platform is attached to the disc and not to the movable vane.

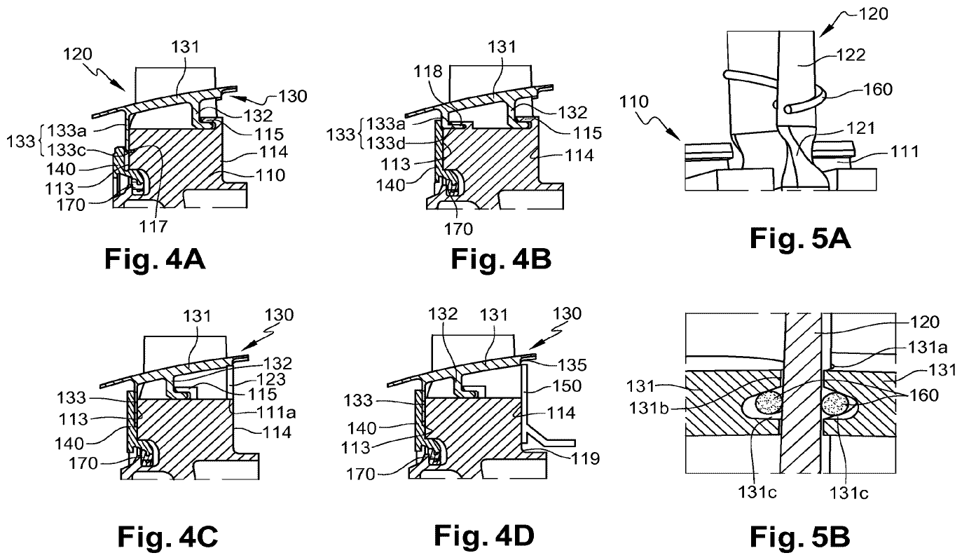

FIGS. 4A, 4B, 4C and 4D represent embodiments different from that previously described in connection with FIGS. 2 and 3. In the embodiment of FIG. 4A, the downstream hook 132 is identical to that previously described for FIG. 2A but the upstream hook 133 differs somewhat. Indeed, in this embodiment, the lug forming the upstream hook 133 is bent at its free end so that the upstream hook has an L-shaped cross-section with a leg 133a substantially radially extending from the main wall 131 towards the disc 110 and an arm 133c substantially perpendicularly extending from the leg 133a in the downstream direction. The arm 133c of the upstream hook 133 is designed to be housed in a rib 117 of the upstream face 113 of the disc 110. The rib 117 of the disc 110 is positioned at a radial height covered upstream by the flange 140 so that, when the arm 133c of the upstream hook 133 is in place in the rib 117, the upstream hook 133 is held integral with the disc 110. Thus, in this embodiment of FIG. 4A, the platform 130 is secured directly to the disc 110 upstream by the upstream hook 133 and downstream by the downstream hook 132. As previously, the architecture of the platform 130 makes it possible to transfer the centrifugal forces from said platform directly to the disc 110, without requiring any additional pieces to those usually used in a LP turbine rotor assembly.

In the embodiment of FIG. 4B, the downstream hook 132 is identical to that previously described for FIG. 2A, but the upstream hook 133 differs somewhat. In this embodiment, the lug forming the upstream hook 133 is bent at its free end so that the upstream hook has an L-shaped cross-section with a leg 133a substantially radially extending from the main wall 131 towards the disc 110 and an arm 133d substantially perpendicularly extending from the leg 133a in the downstream direction. The arm 133d of the upstream hook 133 is designed to be housed in a holding lug 118 at the top of the disc tooth 111. The holding lug 118 of the tooth 111 of the disc 110, which for example has an inverted C-shaped cross-section, is positioned at the top of the tooth 111 in a zone close to the upstream face 113 of the disc 110, the holding hook 115 (the shape of which may be similar to that of the holding lug 118) being positioned in a zone close to the downstream face 114 of the disc 110. In this embodiment, the surface area of the flange 140 may be radially larger than the surface area of a conventional flange so as to cover the upstream face 113 of the disc up to the top of the tooth 111 and at least up to the holding lug in order, when the arm 133d of the upstream hook 133 is in place in the holding lug 118, to keep the upstream hook 133 integral with the disc 110. As for the embodiment of FIG. 4A, the platform 130 is secured directly to the disc 110 upstream by the upstream hook 133 and downstream by the downstream hook 132. As previously, the architecture of the platform 130 makes it possible to transfer the centrifugal forces from said platform directly to the disc 110, without requiring any additional pieces to those usually used in a LP turbine rotor assembly.

In the embodiment of FIG. 4C, the downstream hook 132 is substantially identical to that previously described for FIG. 2A except that it extends from a substantially central zone of the main wall 131 (i.e. a zone that is neither close to the upstream end of the main wall nor close to the downstream end of said main wall) to the holding hook 115. This holding hook 115 is then positioned in a substantially central zone of the top of the tooth 111 (more or less halfway between the upstream face 113 and the downstream face 114 of the disc 110). In this embodiment, the upstream hook 133 includes a planar, rectilinear lug which extends substantially radially from the main wall 131 towards the disc 110, along the upstream face 113 of the disc 110. When the rotor assembly is mounted, the planar lug forming the upstream hook 133 is then inserted between the upstream face 113 of the disc and the flange 140. In this embodiment, the surface area of the flange 140 is radially more extended than the surface area of a conventional flange so as to cover the upstream face 113 of the disc up to the top of the tooth 111 and contain the upstream hook 133 against the upstream face 113 of the disc. As for the embodiment of FIG. 2A, the platform 130 is secured to the disc 110, on the one hand, directly by means of the downstream hook 132 and, on the other hand, indirectly (via the flange 140) by means of the upstream hook 133. To improve its radial hold, the platform 130 may include a radial wall 123 extending in a downstream zone of the platform, from the main wall 131 to the top of the tooth 111 of the disc. This radial wall extends in continuity with the downstream face 114 of the disc, in line with the downstream end 111a of tooth 111. As previously, the architecture of the platform 130 of this embodiment makes it possible to transfer the centrifugal forces from said platform directly to the disc 110, without requiring any additional pieces to those usually used in a LP turbine rotor assembly.

In the embodiment of FIG. 4D, the downstream hook 132 and the upstream hook 133 are identical to those previously described for FIG. 4C. In this embodiment, an axial retaining element 150 is mounted along the downstream face 114 of the disc and the downstream zone of the vane root 121 in order to improve radial hold of the platform 130. This axial retaining element 150 may extend, for example, between a bottom zone 119 of the disc 110 and a shoulder 135 in the main wall 131 of the platform 130. This axial retaining element 150 can perform not only the function of radially holding the platform 130 but also of axially holding the movable vane 120 in the disc 110. As previously, the architecture of the platform 130 in this embodiment makes it possible to transfer the centrifugal forces from said platform directly to the disc 110.

Whatever the embodiment of the platform 130, the rotor assembly 100 can advantageously include a plurality of seal rings 160, as represented in FIGS. 5A and 5B. It preferably includes two seal rings per movable vane 120. Indeed, a seal ring 160 can be housed in a recess 131c made in each of the circumferential end edges 131a and 131b of the main wall 131 of the platform 130. Each of the seal rings 160 is designed to ensure sealing around the blade 122 of the movable vane 120 when the platforms 130 are mounted between the movable vanes. In other words, a seal ring 160 is housed in each recess 131c of the main wall 131 so as to seal the junction between each of the platforms 130 and the lower surface and upper surface of each of the blades 122 and, as such, ensure sealing of the gas circulation stream.

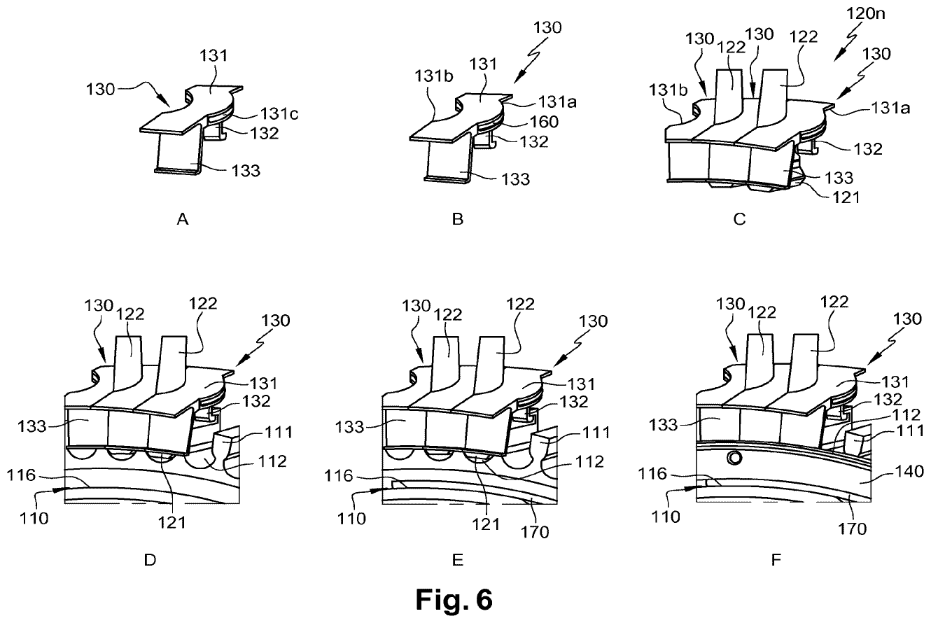

The rotor assembly 100 as described previously is mounted by successively assembling its different pieces. Whatever the embodiment of the platform 130, the method for mounting the rotor assembly 100 may include, for example, the following steps, represented in the drawings A to F of FIG. 6. A first step consists in selecting a first and a second platform 130 adapted to hold the movable vanes 120, as represented in drawing A of FIG. 6. A second step (drawings B of FIG. 6) consists in installing a seal ring 160 in a recess 131c, or rib, of a circumferential end edge 131a or 131b of the main wall 131 of each of the platforms 130. The third step (drawing C in FIG. 6) then consists in assembling the first and second platforms 130 on either side of a blade 122 of movable vane, the seal ring 160 being then compressed between the recess 131c and the lower or upper surface of the blade 122. All the platforms 130 are assembled circumferentially following each other, circumferentially on either side of the blades 122 of the movable vanes so as to form an impeller or crown of movable vanes 120n. The impeller of movable vanes is thus assembled. A fourth step (drawing D in FIG. 6) consists in assembling the impeller of movable vanes 120n in the disc 110 by translating the vane roots 121 into the cavities 112 of the disc 110. This translation is made by sliding each vane root 121 of the impeller of movable vanes 120n in a cavity 112 of the disc, from the upstream face 113 of the disc towards the downstream face 114 of the disc. Once all the vane roots 121 have been installed in the cavities 112, it is checked that the downstream hooks 132 are correctly installed in the first holding lugs 115 and/or that the upstream hooks 133 are correctly installed in the locations provided depending on the embodiment selected. A stop ring 170 is then positioned in the groove 116 of the disc (drawing E in FIG. 6). The groove 116 is a cavity made in the upstream face 113 of the disc around the entire circumference of the disc. The stop ring 170 is a substantially annular part made from a flexible, substantially elastic material (for example from one of the superalloys conventionally used in turbines) and including a radial slot enabling the seal ring to be lowered into the groove 116 for insertion of the flange 140. Finally, a sixth step (drawing F in FIG. 6) consists in positioning the flange 140 at least partially in the groove 116 of the disc by pushing the stop ring 170 into the bottom of the groove so as to ensure securement of the flange to the disc.

Although described through a number of examples, alternatives and embodiments, the rotor assembly according to the invention comprises various alternatives, modifications and improvements which will be obvious to the person skilled in the art, it being understood that these alternatives, modifications and improvements are within the scope of the invention.

1. A turbomachine turbine rotor assembly of axis comprising:
a rotor disc centred on the axis and having cavities which open out at an outer periphery of the disc, two circumferentially adjacent cavities delimiting a tooth of the disc,
movable vanes each comprising a root mounted in one of the cavities of the disc and a blade extending from the root,
a plurality of platforms for holding the movable vanes in the cavities of the disc, each platform being circumferentially mounted between two circumferentially adjacent movable vanes, and
a flange for holding the movable vanes in the cavities,
wherein each platform includes:
a stream wall configured to delimit a gas flow stream of the turbomachine,
an L-shaped downstream hook with the vertical portion of the L radially extending from the stream wall and the horizontal portion of the L housed in a corresponding holding hook positioned at the top of a tooth of the disc; and
an upstream hook substantially radially extending from an upstream zone of the stream wall and axially held between the flange and the disc.

2. The rotor assembly according to claim 1, wherein the flange is annular in shape, radially mounted along an upstream face of the disc.

3. The rotor assembly according to claim 1, wherein the upstream hook of each platform at least partially extends along an upstream face of the disc, between said upstream face of the disc and the flange.

4. The rotor assembly according to claim 1, wherein the upstream hook of each platform is inverted L-shaped with the vertical portion of the inverted L substantially radially extending from the stream wall and the horizontal portion of the inverted L substantially perpendicularly extending from the vertical portion of the inverted L and housed in a groove of the flange.

5. The rotor assembly according to claim 1, wherein the upstream hook of each platform is L-shaped with the vertical portion of the L substantially radially extending from the stream wall and the horizontal portion of the L substantially perpendicularly extending from the vertical portion of the L and housed in a rib of the upstream face of the disc.

6. The rotor assembly according to claim 1, wherein the upstream hook of each platform is L-shaped with the vertical portion of the L substantially radially extending from the stream wall and the horizontal portion of the L substantially perpendicularly extending from the vertical portion of the L and housed in a second holding lug at the top of the tooth of the disc.

7. The rotor assembly according to claim 1, wherein the downstream hook of each platform extends from a downstream zone and/or a central zone of the stream wall, radially in line with the holding hook of the disc tooth.

8. The rotor assembly according to claim 7, includes comprising an axial vane retaining annulus positioned downstream of the disc.

9. The rotor assembly according to claim 7, wherein the platform includes a radial wall extending downstream from the stream wall to the top of a tooth of the disc.

10. The rotor assembly according to claim 1, wherein each platform includes a circumferential end edge with a complementary shape to the shape of a blade of the movable vane, and a seal ring being housed in a recess of the circumferential end edge.

11. The rotor assembly according to claim 1, comprising a stop ring housed in a groove of the rotor disc, at a radially inner end of the flange, the stop ring being configured to secure the flange to the disc after mounting said flange to the disc.

12. A turbomachine comprising a rotor assembly according to claim 1.

13. A method for mounting movable vanes in cavities of a rotor disc, comprising:
selecting a first and a second platform for holding the movable vanes,
installing a seal ring in a recess of a circumferential end edge of a stream wall of each of the first and second platforms,
assembling the first and second platforms circumferentially on either side of a movable vane,
assembling successive platforms, following each other, circumferentially on either side of movable vanes so as to form a crown of movable vanes,
assembling the crown of movable vanes in the disc by translating the vane roots into cavities of the disc from an upstream face of the disc,
positioning a stop ring in a groove of the disc, and
positioning the flange in the groove of the disc, along the upstream face of the disc.
